(19) United States
(12) Patent Application Publication
(10) Pub. No.: US 2025/0056649 A1
(43) Pub. Date: Feb. 13, 2025

(54) METHOD PERFORMED BY USER EQUIPMENT, AND USER EQUIPMENT

(71) Applicant: SHARP KABUSHIKI KAISHA, Sakai City, Osaka (JP)

(72) Inventors: LEI LIU, Shanghai (CN); RENMAO LIU, Shanghai (CN)

(21) Appl. No.: 18/723,728

(22) PCT Filed: Dec. 23, 2022
(86) PCT No.: PCT/CN2022/141464

§ 371 Date: Jun. 24, 2024

(30) Foreign Application Priority Data
Dec. 27, 2021 (CN) 202111617805.7

(51) Int. Cl. H04W 76/27; H04W 76/18; H04W 88/04

(52) U.S. Cl. CPC H04W 76/27; H04W 76/18; H04W 88/04

(57) ABSTRACT

The present invention provides a method performed by user equipment, and user equipment. The method includes: when a relay UE satisfies at least one of the following conditions, transmitting, by the relay UE, a notification message to a connected remote UE; and/or receiving, by the remote UE, the notification message transmitted by the relay UE, and when the remote UE is an L2 U2N remote UE in an RRC connected state, and an indication type carried in the notification message satisfies a specified condition, performing, by the remote UE, at least one of the following operations: performing a behavior of entering an RRC idle state; and initiating relay selection, wherein the conditions include: the relay UE is not triggered by the reception of an RRC release message to enter the RRC idle state; integrity protection of an RRC re-establishment message fails; an upper layer requests to enter the RRC idle state or requests to release an RRC connection; and RRC connection resumption fails.

### BACKGROUND

At the 3rd Generation Partnership Project (3GPP) RAN #80 plenary meeting held in June 2018, a V2X feasibility research project of Release 16 based on 5G NR network technologies (see Non-Patent Document: RP-181480, New SID Proposal: Study on NR V2X) was approved. The primary function included in NR V2X of Release 16 is to support unicast, multicast, and broadcast in out-of-coverage and in-coverage scenarios.

At the RAN #86 plenary meeting in December 2019, a study item on NR sidelink relaying of Release 17 was proposed (see Non-Patent Document: RP-193253, New Study Item on NR Sidelink Relaying), and was approved. Regarding the latest release of the study item, see Non-Patent Document: RP-201474, revised SID: NR Sidelink Relay. The study item mainly studies the solution to user equipment (UE)-to-network and UE-to-UE relaying, so as to extend sidelink-based coverage. The goals of the study item include supporting a sidelink control plane procedure and selection and reselection of relay UE.

At the RAN #91 plenary meeting in March 2020, a work item on NR sidelink relaying of Release 17 was proposed (see Non-Patent Document: RP-210904, New Study Item on NR Sidelink Relaying), and was approved. Regarding the latest release of the work item, see Non-Patent Document: RP-212601, revised WID: NR Sidelink Relay. One of the goals of the work item is to standardize a sidelink control plane procedure, such as management of an RRC connection, reception of a system message, and reception of paging. The goals of the work item further include standardizing a selection and reselection procedure of sidelink relay UE.

Remote UE, in order to perform sidelink communication with a base station or another remote UE, may need to select one relay UE to provide a relay service for the remote UE. In a UE-to-base station relay architecture, a Uu RRC connection may be set up between a remote UE and a base station. In a UE-to-UE relay architecture, a PC5 RRC connection may be set up between a source UE and a target UE. When the remote UE selects a relay UE to serve the remote UE, the remote UE may also perform relay UE reselection due to various conditions.

The present invention discusses processing performed by remote UE and relay UE upon normal release and abnormal release of a Uu RRC connection, and processing performed by source UE and target UE upon release of a PC5-RRC connection.

### SUMMARY

A method performed by user equipment (UE) according to a first aspect of the present invention comprises: when a relay UE satisfies at least one of the following conditions, transmitting, by the relay UE, a notification message to a connected remote UE; and/or receiving, by the remote UE, the notification message transmitted by the relay UE, and when the remote UE is an L2 U2N remote UE in an RRC connected state, and an indication type carried in the notification message satisfies a specified condition, performing, by the remote UE, at least one of the following operations: performing a behavior of entering an RRC idle state; and initiating relay selection, wherein the conditions comprise: a first condition: the relay UE is not triggered by reception of an RRC release message to enter the RRC idle state; a second condition: integrity protection of an RRC re-establishment message fails; a third condition: an upper layer requests to enter the RRC idle state or requests to release an RRC connection; and a fourth condition: RRC connection resumption fails.

In the method according to the first aspect of the present invention, before determining the condition, the method further comprises: if the relay UE satisfies the first condition, the relay UE sets an indication type information element in the notification message to a certain specific first value, wherein the first value indicates Uu RRC connection local release of the relay UE or Uu RRC connection abnormal release of the relay UE, or that Uu RRC connection release of the relay UE is not triggered by the reception of an RRC release message; if the relay UE satisfies the second condition, the relay UE sets the indication type information element in the notification message to a certain specific second value, wherein the second value indicates that the relay UE has failed to protect the integrity of an RRC re-establishment message; if the relay UE satisfies the third condition, the relay UE sets the indication type information element in the notification message to a certain specific third value, wherein the third value indicates that the relay UE has failed at RRC connection resumption; and if the relay UE satisfies the fourth condition, the relay UE sets the indication type information element in the notification message to a certain specific fourth value, wherein the fourth value indicates that the upper layer of the relay UE requests the relay UE to enter the RRC idle state or to release an RRC connection as required by the upper layer.

In the method according to the first aspect of the present invention, the specified condition that must be satisfied by the indication type is at least one of the following: the indication type indicates that Uu RRC connection local release of the relay UE, or Uu RRC connection abnormal release of the relay UE, or Uu RRC connection release of the relay UE is not triggered by the reception of an RRC release message; the indication type indicates that the relay UE has failed to protect the integrity of an RRC re-establishment message; and the indication type indicates that the upper layer of the relay UE requests the relay UE to enter the RRC idle state or the upper layer requests to release an RRC connection.

A method performed by user equipment (UE) according to a second aspect of the present invention comprises: when a relay UE releases a PC5-RRC connection between the relay UE and a target UE not due to a request of an upper layer or the discovery of a radio link failure (RLF), transmitting, by the relay UE, a notification message to a connected source UE; and/or receiving, by the source UE, the notification message transmitted by the relay UE, and performing at least one of the following operations: releasing a PC5-SRAP entity; if a PC5-SRAP entity is no longer associated with any relay UE or target UE, or the PC5-SRAP entity is no longer associated with any UE, releasing the PC5-SRAP entity; releasing a relay PC5 RLC bearer; and if all PC5 links of a target UE corresponding to or borne by a certain relay PC5 RLC bearer have been released, or a certain relay PC5 RLC bearer is not associated with any target UE, releasing the relay PC5 RLC bearer.

In the method according to the second aspect of the present invention, the notification message is a sidelink notification message or any other message for indicating, to the remote UE, information that a PC5 RRC connection of the relay UE is abnormal or one or more certain bits in the message, and/or the relay UE sets the indication type in the notification message to a certain specific value, the value indicating that the UE releases a PC5-RRC connection with the target UE due to another reason.

A method performed by user equipment (UE) according to a third aspect of the present invention comprises: when a relay UE releases a Uu RRC connection to enter an RRC idle state, performing, by the relay UE, at least one of the following operations: releasing an SRAP configuration; releasing an SRAP entity; releasing an RLC bearer not associated with a PDCP; and releasing an RLC entity not associated with a PDCP, and/or the method further comprises: when a remote UE releases a Uu RRC connection to enter the RRC idle state, performing, by the remote UE, at least one of the following operations: releasing a PC5-SRAP configuration; releasing a PC5-SRAP entity; releasing a PC5 RLC bearer not associated with an SL-PDCP; and releasing a PC5 RLC entity not associated with the SL-PDCP.

In the method according to the third aspect of the present invention, the method further comprises: when a first UE releases a PC5-RRC connection with a second UE or a third UE, performing, by the first UE, at least one of the following operations: releasing a PC5-SRAP entity; if a PC5-SRAP entity is no longer associated with any second UE or third UE, or if the PC5-SRAP entity is no longer associated with any UE, releasing the PC5-SRAP entity; releasing a relay PC5 RLC bearer; when the first UE releases a PC5-RRC connection with the second UE, if all PC5 links of the second UE corresponding to or borne by a certain relay PC5 RLC bearer have been released, or if a certain relay PC5 RLC bearer is not associated with any second UE, releasing the relay PC5 RLC bearer; and when the relay UE releases a PC5-RRC connection with the third UE, if all PC5 links of the third UE corresponding to or borne by a certain relay PC5 RLC bearer have been released, or if a certain relay PC5 RLC bearer is not associated with any third UE, releasing the relay PC5 RLC bearer, wherein when the first UE is a relay UE, the second UE is a source UE, and the third UE is a target UE; when the first UE is a source UE, the second UE is a target UE, and the third UE is a relay UE; and when the first UE is a target UE, the second UE is a source UE, and the third UE is a relay UE.

The method according to a fourth aspect of the present invention comprises: when the UE receives an RRC release message, and the message carries a suspend configuration suspendConfig information element, performing, by the UE, at least one of the following operations: if the UE is a remote UE, suspending, by the UE, a PC5 RLC bearer not associated with a packet data convergence protocol (PDCP); and if the UE is an L2 U2N relay UE, suspending, by the UE, an RLC bearer not associated with the PDCP, and/or the method further comprises: when the UE needs to resume an RRC connection due to a radio access network (RAN) paging area update needing to be performed or an upper layer having data that needs to be transmitted to a base station, transmitting, by the UE, an RRC connection resume request RRCResumeRequest or RRCResumeRequest1 message to the base station, and performing, by the UE, at least one of the following operations when transmitting the RRCResumeRequest or RRCResumeRequest1 message: if the UE is a remote UE, resuming, by the UE, the PC5 RLC bearer not associated with the PDCP; and if the UE is an L2 U2N relay UE, resuming, by the UE, the RLC bearer not associated with the PDCP.

User equipment according to a fifth aspect of the present invention comprises: a processor; and a memory storing instructions, wherein the instructions, when run by the processor, perform the method according to any one of the first aspect, the second aspect, the third aspect, and the fourth aspect.

### BENEFICIAL EFFECTS OF PRESENT INVENTION

In an L2 U2N architecture, when remote UE and relay UE in RRC_INACTIVE or RRC_CONNECTED enter RRC_IDLE, an SRAP and an RLC bearer can be cleaned, and when the remote UE and the relay UE enter RRC_IDLE abnormally, signaling can be exchanged between the relay UE and the remote UE, and related operations can be performed. In an L2 U2U scenario, when source UE and target UE release a PC5-RRC connection, an SRAP and an RLC bearer can be cleaned.

In summary, by means of the present invention, in one aspect, unwanted configuration information is removed in a timely manner, thereby avoiding errors, and reducing memory usage. In another aspect, remote UE is enabled to promptly sense an exception and promptly initiate relay selection or reselection, thereby reducing delay and ensuring quality of service.

### BRIEF DESCRIPTION OF THE DRAWINGS

FIG. 1 is a schematic diagram showing UE-to-UE relay.

FIG. 2 (a), FIG. 2 (b), and FIG. 2 (c) are schematic diagrams respectively showing scenarios 1, 2, and 3 of UE-to-network relay.

FIG. 3 is a schematic diagram showing control plane protocol stacks of remote UE, relay UE, and a base station in a U2N sidelink layer-2 (L2) relay architecture.

FIG. 4 is a schematic diagram showing control plane protocol stacks of source UE, relay UE, and target UE in a U2N sidelink layer-2 (L2) relay architecture.

FIG. 5 is a schematic diagram showing a basic procedure of a method performed by user equipment according to Embodiment 1 of the invention.

FIG. 6 is a schematic diagram showing a basic procedure of a method performed by user equipment according to Embodiment 2 of the invention.

FIG. 7 (a) and FIG. 7 (b) are schematic diagrams respectively showing basic procedures of methods performed by user equipment in a U2N scenario and a U2U scenario according to Embodiment 3 of the invention.

FIG. 8 is a schematic diagram showing a basic procedure of a method performed by user equipment according to Embodiment 4 of the invention.

FIG. 9 is a block diagram showing user equipment according to an embodiment of the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The following describes some terms involved in the present invention. For the specific meanings of the terms, please see the latest 3GPP standards and specifications.
UE: User Equipment
NR: New Radio
MAC: Medium Access Control
MAC CE: MAC control element
RLC: Radio Link Control
SDAP: Service Data Adaptation Protocol
PDCP: Packet Data Convergence Protocol
RRC: Radio Resource Control
RRC_CONNECTED: RRC connected state
RRC_INACTIVE: RRC inactive state
RRC_IDLE: RRC idle state
RAN: Radio Access Network
Sidelink: sidelink
SCI: Sidelink Control Information
AS: Access Stratum
IE: Information Element
CE: Control Element
MIB: Master Information Block
NR: New Radio
SIB: System Information Block
NG-RAN: NG Radio Access Network
DCI: Downlink Control Information
ADAPT: adaptation layer
PHY: physical layer
RB: Radio Bearer
DRB: Data Radio Bearer
SRB: Signalling Radio Bearer
eDRX: Extended DRX
Uu: Uu
ProSe: Proximity based Services
V2X: Vehicle-to-Everything
NAS: Non-Access Stratum
PC5-S: PC5 signalling
SRAP: Sidelink Relay Adaptation Protocol
U2N: UE-to-Network
U2U: UE-to-UE
L2: Layer 2
RSRP: Reference Signal Received Power
SL-RSRP: Sidelink RSRP
SD-RSRP: Sidelink Discovery RSRP
RLF: Radio Link Failure

In the present invention, a network, a base station, and a RAN may be used interchangeably. The network may be a Long Term Evolution (LTE) network, a new RAT (NR) network, an enhanced Long Term Evolution (eLTE) network, or another network defined in a subsequent evolved version of the 3GPP.

In the present invention, user equipment (UE) may refer to an NR device that supports an NR sidelink relay function as described in the background, may also refer to an NR device that supports an NR sidelink relay architecture, and may also refer to an NR device or an LTE device of another type. Remote UE may refer to UE connected with the network via U2N relay UE, or may refer to UE having execution capabilities of NR sidelink U2N remote UE. Relay UE may refer to UE that supports providing connectivity to the network for remote UE, or UE having the foregoing capability. Source UE and target UE may refer to two UEs connected to each other by means of relay UE in a UE-to-UE relay architecture.

For a U2N scenario, “relay UE”, “U2N relay UE”, and “L2 U2N relay UE” are interchangeable. “Remote UE”, “U2N remote UE”, and “L2 U2N remote UE” are interchangeable.

For a U2U scenario, “relay UE”, “U2U relay UE”, and “L2 U2U relay UE” are interchangeable. “Remote UE”, “U2U remote UE”, and “L2 U2U remote UE” are interchangeable. “Source UE”, “source remote UE”, “U2U source UE”, “U2U source remote UE”, “L2 U2U source UE”, and “L2 U2U source remote UE” are interchangeable. “Target UE”, “target remote UE”, “U2U target UE”, “U2U target remote UE”, “L2 U2U target UE”, and “L2 U2U target remote UE” are interchangeable.

In the present invention, sidelink and PC5 are interchangeable. “Feedback”, “report”, “reporting”, “transmission”, and “notification” are interchangeable. “Activation”, “employing”, “application”, “enabling”, “activating”, “implementation”, etc., are interchangeable.

In the present invention, an upper layer may refer to a ProSe layer, a V2X layer, a NAS layer, or a PCS-S protocol layer.

In the present invention, a ProSe layer, a V2X layer, a NAS layer, and a PC5-S protocol layer are interchangeable.

In the present invention, an RLC channel, an RLC entity, and an RLC bearer are interchangeable. Optionally, “relay” may further be added as a limitation before the foregoing names.

It should be noted that in the present specification, two items that are connected by “and”, “or”, or “and/or” may indicate different expression methods for the same intent in different application scenarios. It is possible that a relationship of including or being included in is present between the two items, but it is not necessary that the two items refer to completely different content.

Hereinafter, a description will be given of related art of the present invention.

A PC5 interface is an interface for performing control plane and user plane sidelink communication between UE and UE. For sidelink unicast, a PC5-RRC connection is an AS layer logical connection between a pair of a source layer-2 ID and a target layer-2 ID. Establishment of one PC5 unicast link corresponds to establishment of one PC5-RRC connection.

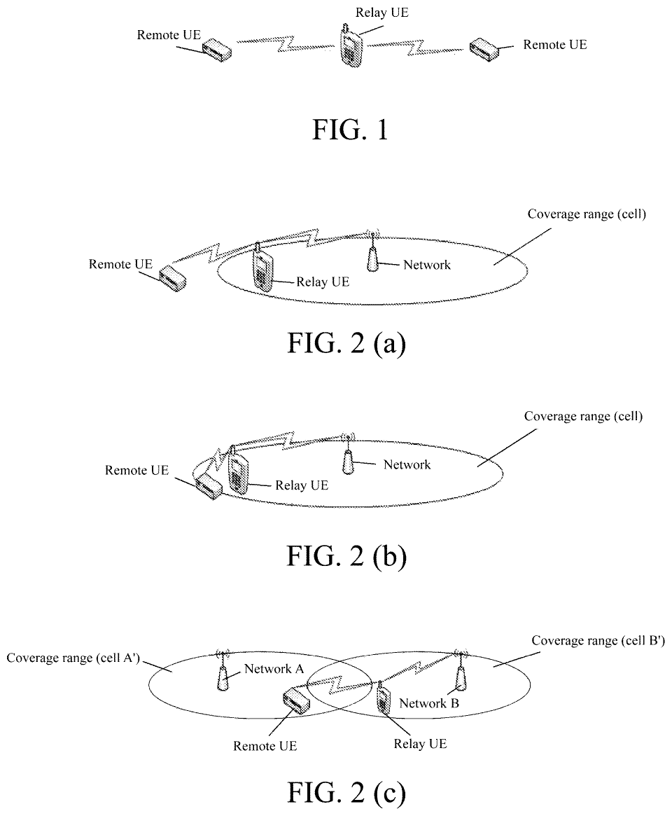

UE-to-UE relaying is as shown in FIG. 1. The left and the right are remote UEs, and the middle is a relay UE. The remote UEs are respectively connected to the relay UE by means of PC5 interfaces. Because the two remote UEs are far from each other or because a communication environment is poor, the relay UE is needed to relay and forward signaling and data therebetween.

UE-to-UE relay scenarios include:
1) in coverage: the two remote UEs (i.e., the source UE and the target UE) and the relay UE are all in coverage;
2) out of coverage: the two remote UEs (i.e., the source UE and the target UE) and the relay UE are all out of coverage; and
3) partial coverage: among the two remote UEs and the relay UE, at least one UE is in coverage, and at least one UE is out of coverage.

For the NR sidelink L2 U2U relay architecture, two remote UEs (i.e., a source UE and a target UE) each set up a PC5-RRC connection with the relay UE, and the two remote UEs (i.e., the source UE and the target UE) also set up a PC5-RRC connection therebetween. The two remote UEs (i.e., the source UE and the target UE) communicate with each other by means of the relay UE.

UE-to-network relaying is as shown in FIGS. 2 (a), (b), and (c). In scenario 1 and scenario 2 in FIGS. 2 (a) and 2 (b), the left side is a remote UE, the middle is a relay UE, and the right side is a network. In scenario 3 in FIG. 2 (c), both sides are networks (e.g., networks A and B), and the middle, from left to right, is a remote UE and a relay UE, respectively. The remote UE and the relay UE are connected to each other by means of a PC5 interface, and the relay UE is connected to the network by means of a Uu interface. Because the remote UE is far from the network or because the communication environment is poor, the relay UE is needed to relay and forward signaling and data between the remote UE and the network.

UE-to-network relay scenarios include:
1) the remote UE is out of coverage, and the relay UE is in coverage;
2) the remote UE and the relay UE are both in coverage, and are in the same cell; and
3) the remote UE and the relay UE are both in coverage, but are in different cells (e.g., cells A′ and B′).

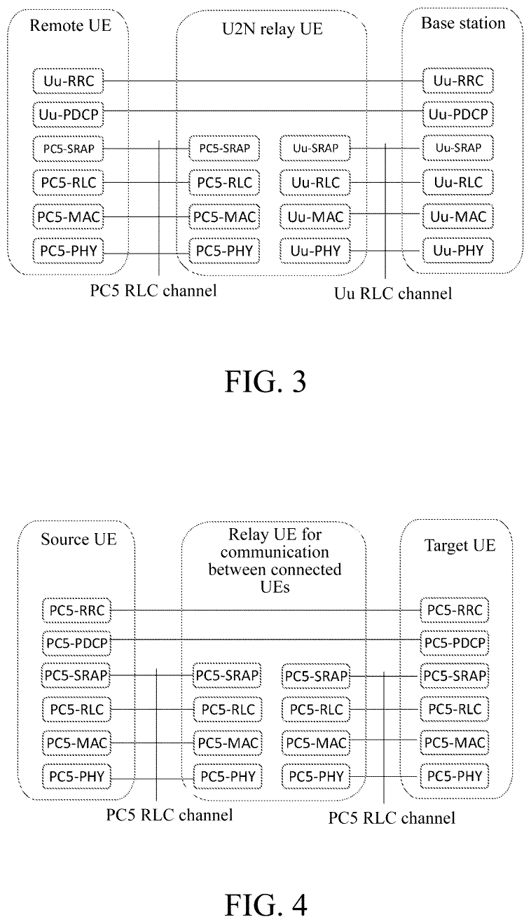

For a U2N sidelink layer-2 (L2) relay architecture, control plane protocol stacks of remote UE, relay UE, and a base station are as shown in FIG. 3.

For a U2U sidelink layer-2 (L2) relay architecture, control plane protocol stacks of source UE, relay UE, and target UE are as shown in FIG. 4.

The PC5 RLC entity refers to an RLC entity for PC5 interface communication. In the U2N architecture, when the remote UE is connected to the base station by means of the relay UE, the PC5 RLC entity bears information from a Uu PDCP entity, so that such a PC5 RLC entity may also be referred to as a PC5 RLC bearer. In the U2U architecture, when the source UE is connected to the target UE by means of the relay UE, the PC5 RLC entity may bear data information between the source UE and the target UE.

The RLC entity refers to an RLC entity for Uu interface communication. When the remote UE is connected to the base station by means of the relay UE, the RLC entity may bear data from different bearers of the same remote UE, and may also bear data from a plurality of remote UEs.

A PC5 SRAP entity refers to an SRAP entity for PC5 interface communication. In the L2 U2N architecture, when the remote UE is connected to the base station by means of the relay UE, the PC5 SRAP of the remote UE determines, according to a configured mapping relationship between an end-to-end bearer and a PC5 RLC bearer, a PC5 RLC bearer corresponding to uplink data (data transmitted by the UE to the base station), and determines a PC5 RLC bearer corresponding to downlink data from the base station and forwarded by the relay UE. A PC5 SRAP entity corresponding to the remote UE side is also present in the relay UE. In the L2 U2U architecture, when the source UE is connected to the target UE by means of the relay UE, the PC5 SRAP of the source UE determines, according to a configured mapping relationship between an end-to-end bearer and a PC5 RLC bearer, a PC5 RLC bearer corresponding to uplink data (data transmitted by the UE to the target UE), and determines a PC5 RLC bearer corresponding to downlink data from the target UE and forwarded by the relay UE. A PC5 SRAP entity corresponding to the remote UE side is also present in the relay UE. A PC5-SRAP is also present in the target UE, and has the same function as the PC5-SRAP in the source UE.

The Uu SRAP entity refers to an SRAP entity for Uu interface communication. In the L2 U2N architecture, the relay UE may transmit received data information of the remote UE to a corresponding Uu RLC bearer by means of a Uu SRAP entity according to a configured mapping relationship between an end-to-end bearer and a Uu RLC bearer, and may transmit, to a corresponding remote UE, received data information from the base station, thereby achieving a mapping or adaptation function.

In essence, the PC5 SRAP entity and the Uu SRAP entity both refer to an SRAP entity that follows an SRAP protocol stack, but are used for different communication interfaces. The entity and the layer, such as an SRAP entity or an SRAP layer, are interchangeable herein.

### Uu RRC Connection and State

A reference point between UE and a radio access network is referred to as Uu, so that a connection between the UE and the radio access network is referred to as a Uu connection. In a Uu connection, depending on the state of a Uu RRC connection, the state of UE can be an idle state (RRC_IDLE state), an inactive state (RRC_INACTIVE state), or a connected state (RRC_CONNECTED state). After an RRC connection is established, the UE may be in the RRC_INACTIVE or RRC_CONNECTED state. If no RRC connection is established, the UE is in the RRC_IDLE state.

After an RRC connection is established between the remote UE and a radio access network, the remote UE may be in the RRC_INACTIVE or RRC_CONNECTED state. If no RRC connection is established, the UE is in the RRC_IDLE state. Similarly, the relay UE may also be in one of these three states. Upon receiving an RRCRelease message transmitted by the network and carrying suspendConfig, the remote UE in the RRC_CONNECTED or RRC_INACTIVE state enters or returns to the RRC_INACTIVE state. Upon receiving an RRCRelease message transmitted by the network and carrying no suspendConfig, the remote UE in the RRC_CONNECTED or RRC_INACTIVE state enters the RRC_IDLE state.

It should be noted that when the remote UE is in RRC_CONNECTED, the relay UE must be in RRC_CONNECTED. When the remote UE is in RRC_INACTIVE/IDLE, the relay UE may be in any one of the three states, i.e., RRC_CONNECTED/INACTIVE/IDLE.

After the remote UE selects a relay UE to provide a relay service for the remote UE, since there is data in an application layer that needs to be transmitted, the application layer triggers a procedure of setting up a PC5 unicast link between a ProSe layer and the relay UE. After the PC5 unicast link is set up, the ProSe layer instructs an AS layer, and the AS layer sets up a PC5-RRC connection as required by the ProSe. For the NR sidelink L2 U2N relay architecture, procedures such as RRC connection establishment, release, re-establishment, and resumption, may be present between the remote UE and the network. The remote UE can establish a Uu RRC connection with a network by means of the relay UE for data transmission between the remote UE and the network. The remote UE encapsulates messages of performing RRC connection establishment, re-establishment, resumption, etc., to the network in PC5 signaling or data, and transmits the PC5 signaling or data to the relay UE, and the relay UE forwards the PC5 signaling or data to the network upon receiving the PC5 signaling or data. Conversely, an RRC message returned by the network is encapsulated in PC5 signaling or data by the relay UE and forwarded to the remote UE. The remote UE can acquire a system message of a cell via the relay UE. The remote UE can also receive a paging message of the network via the relay UE.

After the remote UE establishes a connection to the network and enters RRC_CONNECTED, relay selection and/or reselection is stopped. However, the remote UE may trigger relay selection and/or reselection according to various reasons such as a PC5 link measurement result, or an indication from the upper layer, or an indication from relay UE.

A typical scenario discussed in the present invention is: in an L2 U2N architecture, when remote UE and relay UE in RRC_INACTIVE or RRC_CONNECTED enter RRC_IDLE, how to clean an SRAP and an RLC bearer, and when the remote UE and the relay UE enter RRC_IDLE abnormally, how the relay UE and the remote UE exchange signaling therebetween and perform related operations, and in an L2 U2U scenario, when source UE and target UE release a PC5-RRC connection, how to clean an SRAP and an RLC bearer. By means of the present invention, in one aspect, unwanted configuration information is removed in a timely manner, thereby avoiding errors, and reducing memory usage. In another aspect, remote UE is enabled to promptly sense an exception and promptly initiate relay selection or reselection, thereby reducing delay and ensuring quality of service.

Hereinafter, several embodiments of the present invention for addressing the above problems are described in detail.

### Embodiment 1

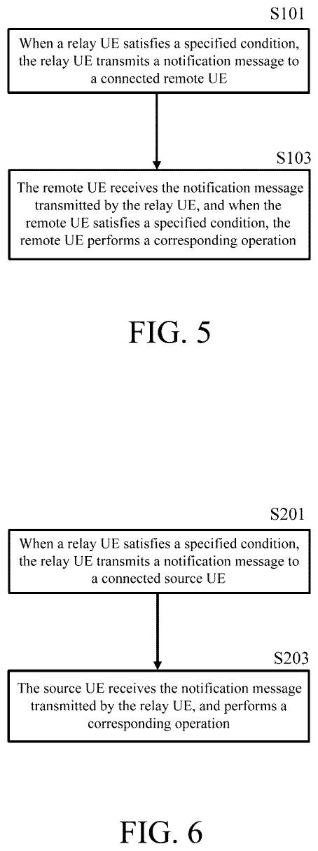

The present embodiment is related to U2N, and as shown in FIG. 5, the present embodiment includes steps 101 and 103.

Optionally, in step 101, when a relay UE satisfies the following condition, transmitting, by the relay UE, a notification message to a connected remote UE (connected U2N remote UE). The notification message may be a NotificationMessageSidelink message or any other message for indicating, to the remote UE, information that a Uu RRC connection of the relay UE is abnormal or one or more certain bits in the message. The condition that the relay UE needs to satisfy is at least one of the following:
The relay UE is not triggered by the reception of an RR (Release message to enter RRC_IDLE;
integrity protection of an RRCRestablishment message fails;
an upper layer requests to enter RRC_IDLE or requests to release an RRC connection; and
RRC connection resumption fails.

Optionally, determination of whether the relay UE is in RRC_CONNECTED may also be added before determination of the condition. That is, if the relay UE is in RRC_CONNECTED, and at least one of the conditions described above is satisfied, the notification message is transmitted to the remote UE.

Optionally, if the relay UE is not triggered by the reception of an RRCRelease message to enter RRC_IDLE, the relay UE sets an indication type IE (e.g., indicationType or any other IE for the indication function) in the notification message to a certain specific value, and the value indicates that Uu RRC connection local release of the relay UE, or Uu RRC connection abnormal release of the relay UE, or Uu RRC connection release (or entering RRC_IDLE) of the relay UE is not triggered by reception of an RRCRelease message.

Optionally, if the relay UE has failed to protect the integrity of an RR (Reestablishment message, the relay UE sets the indication type IE in the notification message to a certain specific value, and the value may indicate that the relay UE has failed to protect the integrity of the RRCRestablishment message.

Optionally, if the relay UE has failed at RRC connection resumption, the relay UE sets the indication type IE in the notification message to a certain specific value, and the value may indicate that the relay UE has failed at RRC connection resumption.

Optionally, if the relay UE enters RRC_IDLE due to a request by the upper layer or releases an RRC connection as required by the upper layer, the relay UE sets the indication type IE in the notification message to a certain specific value, and the value may indicate that the upper layer of the relay UE requests the relay UE to enter RRC_IDLE or to release an RRC connection as required by the upper layer.

Optionally, in step 103, receiving, by the remote UE, the notification message transmitted by the relay UE, and if the notification message carries an indication type (e.g., indicationType), if the remote UE is an L2 U2N remote UE in RRC_CONNECTED, and if the indication type carried in the notification message satisfies a condition, performing, by the remote UE, at least one of the following operations:
performing a behavior of entering RRC_IDLE, wherein optionally, a release cause value may be “other”; and
initiating relay reselection.

The condition that the indication type (e.g., indicationType) needs to satisfy is at least one of the following:
the indication type indicates that Uu RRC connection local release of the relay UE, or Uu RRC connection abnormal release of the relay UE, or Uu RRC connection release (or entering RRC_IDLE) of the relay UE is not triggered by reception of an RRCRelease message;
the indication type indicates that the relay UE has failed to protect the integrity of the RRCRestablishment message; and
the indication type indicates that the upper layer of the relay UE requests the relay UE to enter RRC_IDLE or the upper layer requests to release an RRC connection.

### Embodiment 2

The present embodiment is related to U2U, and as shown in FIG. 6, includes steps 201 and 203.

Optionally, in step 201, when a relay UE releases a PC5-RRC connection between the relay UE and a target UE not due to a request of an upper layer or the discovery of an RLF, transmitting, by the relay UE, a notification message to a connected source UE. The notification message may be a NotificationMessageSidelink (a sidelink notification message) message or any other message for indicating, to remote UE, information that a PC5 RRC connection of the relay UE is abnormal or one or more certain bits in the message. The relay UE sets an indication type (or any information for indicating the reason why the relay UE releases the PC5-RRC connection) in the notification message to a certain specific value, and the value indicates that the relay UE releases the PC5-RRC connection between the relay UE and target UE due to another reason.

Optionally, in step 203, receiving, by the source UE, the notification message transmitted by the relay UE, and performing, by the source UE, at least one of the following operations:
releasing a PC5-SRAP entity;
if a PC5-SRAP entity is no longer associated with any relay UE or target UE (i.e., no longer associated with a destination L2-ID of any relay UE or target UE), or if the PC5-SRAP entity is no longer associated with any UE (e.g., a destination L2-ID of any UE), releasing the PC5-SRAP entity;
releasing a relay PC5 RLC bearer; and
if all PC5 links of target UE (or a target UE destination address) corresponding to or borne by a certain relay PC5 RLC bearer have been released, or if a certain relay PC5 RLC bearer is not associated with any target UE (or target UE destination address), releasing the relay PC5 RLC bearer.

### Embodiment 3

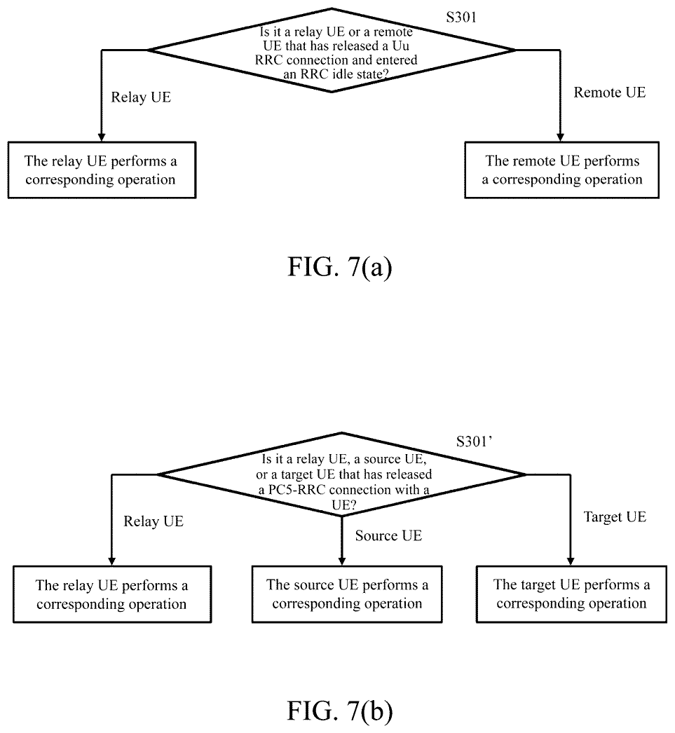

Optionally, for a U2N scenario, as shown in FIG. 7 (a), in step S301, when a relay UE releases a Uu RRC connection to enter RRC_IDLE, performing, by the relay UE, at least one of the following operations:
releasing an SRAP configuration;
releasing an SRAP entity;
releasing an RLC bearer not associated with a PDCP; and
releasing an RLC entity not associated with a PDCP.

The SRAP configuration is configured by a base station, and may include a Uu SRAP configuration and/or a PC5 SRAP configuration. The SRAP entity may include a Uu SRAP entity and/or a PC5 SRAP entity. An “RLC bearer not associated with a PDCP” may also be expressed as a “relay RLC bearer”, and may also be distinguished from an RLC bearer in a non-relay scenario by a dedicated name (e.g., a relaying RLC bearer or any name that expresses said meaning).

Optionally, for a U2N scenario, as shown in FIG. 7 (a), in step S301, when a remote UE releases a Uu RRC connection to enter RRC_IDLE, performing, by the remote UE, at least one of the following operations:
releasing a PC5-SRAP configuration;
releasing a PC5-SRAP entity;
releasing a PC5 RLC bearer not associated with an SL-PDCP; and
releasing a PC5 RLC entity not associated with an SL-PDCP.

An “RLC bearer not associated with an SL-PDCP” may also be expressed as a “relay PC5 RLC bearer” or any name that expresses that the PC5 RLC bearer is for bearing a relay service or bearing an end-to-end service forwarded by a relay.

Optionally, for a U2U scenario, as shown in FIG. 7 (b), in step S301′, when the relay UE releases a PC5-RRC connection between the relay UE and a UE (the UE is a source UE or a target UE), performing, by the relay UE, at least one of the following operations:
releasing a PC5-SRAP entity;
if a PC5-SRAP entity is no longer associated with any source UE or target UE (e.g., no longer associated with a destination L2-ID of any source UE or target UE), or if the PC5-SRAP entity is no longer associated with any UE (e.g., a destination L2-ID of any UE), releasing the PC5-SRAP entity;
releasing a relay PC5 RLC bearer;
when the relay UE releases a PC5-RRC connection between the relay UE and source UE, if all PC5 links of source UE (or a source UE destination address, or the local ID of the source UE) corresponding to or borne by a certain relay PC5 RLC bearer have been released, or if a certain relay PC5 RLC bearer is not associated with any source UE (or any source UE destination address, or the local ID of any source UE), releasing the relay PC5 RLC bearer; and
when the relay UE releases a PC5-RRC connection between the relay UE and target UE, if all PC5 links of target UE (or a target UE destination address) corresponding to or borne by a certain relay PC5 RLC bearer have been released, or if a certain relay PC5 RLC bearer is not associated with any target UE (or target UE destination address), releasing the relay PC5 RLC bearer.

When a relay PC5 RLC bearer is released, determination may be further performed, and if the relay UE releases a PC5-RRC connection between the relay UE and source UE, a relay PC5 RLC bearer corresponding to the source UE (e.g., a destination L2-ID of the source UE) or associated with the source UE is released. If the relay UE releases a PC5-RRC connection between the relay UE and target UE, a relay PC5 RLC bearer corresponding to the target UE (e.g., a destination L2-ID of the target UE) or associated with the target UE is released.

Optionally, for a U2U scenario, as shown in FIG. 7 (b), in step S301′, when a source UE releases a PC5-RRC connection between the source UE and a UE (the UE is a relay UE or a target UE), performing, by the source UE, at least one of the following operations:
releasing a PC5-SRAP entity;
if a PC5-SRAP entity is no longer associated with any relay UE or target UE (i.e., no longer associated with a destination L2-ID of any relay UE or target UE), or if the PC5-SRAP entity is no longer associated with any UE (e.g., a destination L2-ID of any UE), releasing the PC5-SRAP entity;
releasing a relay PC5 RLC bearer;
when the source UE releases a PC5-RRC connection between the source UE and target UE, if all PC5 links of target UE (or a target UE destination address) corresponding to or borne by a certain relay PC5 RLC bearer have been released, or if a certain relay PC5 RLC bearer is not associated with any target UE (or target UE destination address), releasing the relay PC5 RLC bearer; and
when the source UE releases a PC5-RRC connection between the source UE and relay UE, if all PC5 links of relay UE (or a relay UE destination address) corresponding to or borne by a certain relay PC5 RLC bearer have been released, or if a certain relay PC5 RLC bearer is not associated with any relay UE (or relay UE destination address), releasing the relay PC5 RLC bearer.

Optionally, for a U2U scenario, as shown in FIG. 7 (b), in step S301′, when a target UE releases a PC5-RRC connection between the target UE and a UE (the UE is a relay UE or a source UE), performing, by the target UE, at least one of the following operations:
releasing a PC5-SRAP entity;
if a PC5-SRAP entity is no longer associated with any relay UE or source UE (i.e., no longer associated with a destination L2-ID of any relay UE or source UE), or if the PC5-SRAP entity is no longer associated with any UE (e.g., a destination L2-ID of any UE), releasing the PC5-SRAP entity;
releasing a relay PC5 RLC bearer;
when the target UE releases a PC5-RRC connection between the target UE and source UE, if all connections of the source UE (or a source UE destination address) corresponding to or borne by a certain relay PC5 RLC bearer have been released, or if a certain relay PC5 RLC bearer is not associated with any source UE (or source UE destination address), releasing the relay PC5 RLC bearer; and
when the target UE releases a PC5-RRC connection between the target UE and relay UE, if all connections of relay UE (or a relay UE destination address) corresponding to or borne by a certain relay PC5 RLC bearer have been released, or if a certain relay PC5 RLC bearer is not associated with any relay UE (or relay UE destination address), releasing the relay PC5 RLC bearer.

The relay PC5 RLC bearer refers to a PC5 PLC bearer for a relay function or any name that expresses that the PC5 RLC bearer is for bearing a relay service or bearing an end-to-end service forwarded by a relay.

### Embodiment 4

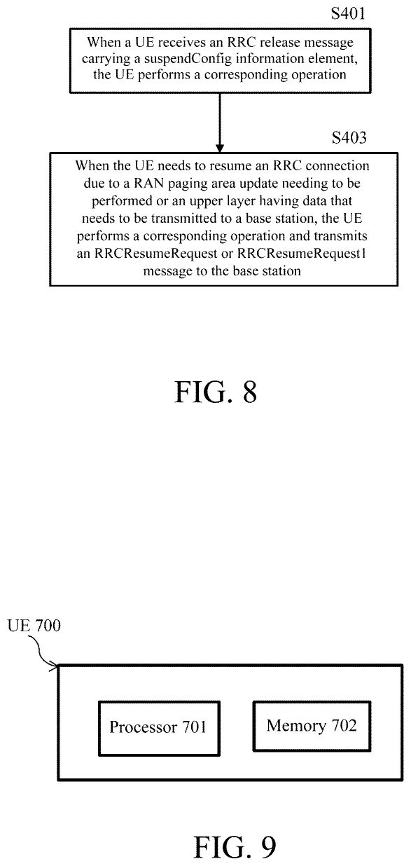

The present embodiment, as shown in FIG. 8, includes steps 401 and 403.

Optionally, in step 401, receiving, by a UE, an RRCRelease message, and if the message carries a suspendConfig information element, performing, by the UE, at least one of the following actions:
if the UE is connected to an L2 U2N relay UE by means of a PC5-RRC connection, i.e., the UE is a remote UE, suspending, by the UE, a PC5 RLC bearer not associated with a PDCP; and
if the UE is an L2 U2N relay UE, suspending, by the UE, an RLC bearer not associated with a PDCP.

Optionally, in step 403, when the UE needs to resume an RRC connection due to a RAN paging area update needing to be performed or an upper layer having data that needs to be transmitted to a base station, transmitting an RRCResumeRequest (an RRC connection resume request) or RRCResumeRequest1 message to the base station. When the RRCResumeRequest or RRCResumeRequest1 message is transmitted, the UE performs at least one of the following actions:
if the UE is connected to an L2 U2N relay UE by means of a PC5-RRC connection, i.e., the UE is a remote UE, resuming, by the UE, a PC5 RLC bearer not associated with a PDCP; and
if the UE is an L2 U2N relay UE, resuming, by the UE, an RLC bearer not associated with a PDCP.

An “RLC bearer not associated with a PDCP” may also be expressed as a “relay RLC bearer”, and may also be distinguished from an RLC bearer in a non-relay scenario by a dedicated name (e.g., a relaying RLC bearer or any name that expresses said meaning).

### Embodiment 5

In the present embodiment, when a UE initiates an RRC connection reestablishment procedure, the UE performs at least one of the following actions:
if the UE is connected to an L2 U2N relay UE by means of a PC5-RRC connection, i.e., the UE is a remote UE, suspending, by the UE, a PC5 RLC bearer not associated with a PDCP; and
if the UE is an L2 U2N relay UE, suspending, by the UE, an RLC bearer not associated with a PDCP.

An “RLC bearer not associated with a PDCP” may also be expressed as a “relay RLC bearer”, and may also be distinguished from an RLC bearer in a non-relay scenario by a dedicated name (e.g., a relaying RLC bearer or any name that expresses said meaning).

FIG. 9 is a simplified structural block diagram of user equipment (UE) according to the present invention. As shown in FIG. 9, the user equipment (UE) 700 includes a processor 701 and a memory 702. The processor 701 may include, for example, a microprocessor, a microcontroller, an embedded processor, and the like. The memory 702 may, for example, include a volatile memory (for example, a random access memory (RAM)), a hard disk drive (HDD), a non-volatile memory (for example, a flash memory), or other memories. The memory 702 has program instructions stored thereon. The instructions, when run by the processor 701, can perform the above method performed by user equipment described in detail in the present invention.

The program running on the device according to the present invention may be a program that enables the computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by a computer system. The so-called “computer system” may be a computer system embedded in the device, which may include operating systems or hardware (for example, peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed via circuits (for example, monolithic or multi-chip integrated circuits). Circuits designed to execute the functions described in the present specification may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-9. (canceled)

10. A User equipment (UE), which is a layer 2 (L2) UE-to-Network (U2N) relay UE, comprising:
a processor; and
a memory storing instructions,
wherein the processor is configured by the instructions to:
determine a configured mapping between a) a bearer and b) a relay Radio Link Control (RLC) channel which is used for Uu interface communication; and
suspend the relay RLC channel upon initiation of a Radio Resource Control (RRC) connection re-establishment procedure, wherein
the L2 U2N relay UE is a UE that supports provision of connectivity to a network for a L2 U2N Remote UE,
the L2 U2N Remote UE is a UE that connects with the network via the L2 U2N relay UE,
the relay RLC channel is an RLC channel between the L2 U2N relay UE and a base station, and
the relay RLC channel is used to provide communication for L2 U2N relay.

11. A layer 2 (L2) UE-to-Network (U2N) relay method performed by a user equipment (UE), which is a L2 U2N relay UE, the L2 U2N relay method comprising:
determining a configured mapping between a) a bearer and b) a relay Radio Link Control (RLC) channel which is used for Uu interface communication; and
suspending the relay RLC channel upon initiation of a Radio Resource Control (RRC) connection re-establishment procedure, wherein
the L2 U2N relay UE is a UE that supports provision of connectivity to a network for a L2 U2N Remote UE,
the L2 U2N Remote UE is a UE that connects with the network via the L2 U2N relay UE,
the relay RLC channel is an RLC channel between the L2 U2N relay UE and a base station, and
the relay RLC channel is used to provide communication for the L2 U2N relay.
